(19) United States
(12) Patent Application Publication
(10) Pub. No.: US 2023/0300510 A1
(43) Pub. Date: Sep. 21, 2023

(54) INTERMEDIARY DEVICE AND WEARABLE BRIDGE

(71) Applicant: Audiowise Technology Inc., Hsinchu (TW)

(72) Inventor: YU-FENG CHEN, Hsinchu (TW)

(21) Appl. No.: 17/695,911

(22) Filed: Mar. 16, 2022

(51) Int. Cl. H04R 1/10; H02J 7/00

(52) U.S. Cl. CPC H04R 1/1041; H04R 1/1008; H04R 1/1016; H04R 1/105; H04R 1/1075; H04R 1/1025; H04R 1/1066; H02J 7/0042; H04R 2420/07; H02J 7/0063

(57) ABSTRACT

An intermediary device and a wearable bridge are provided. The wearable bridge is detachably assembled with two wireless earbuds, and includes a headband, two ear cups respectively connected to two opposite ends of the headband, and a wireless module. Each ear cup includes an assembling slot and an electrical connector that is arranged in the assembling slot. Each assembling slot can be assembled with one of the two wireless earbuds so as to enable the corresponding electrical connector to be structurally and electrically connected to the one of the two wireless earbuds. The wireless module is electrically coupled to the electrical connector of each of the two ear cups, and the wireless module is configured to transmit sound signals from an external apparatus to the electrical connectors of the two ear cups, so that the two wireless earbuds are allowed to synchronously play.

### FIELD OF THE DISCLOSURE

The present disclosure relates to an audio intermediary device, and more particularly to an intermediary device and a wearable bridge for being detachably assembled with at least one wireless earbud.

### BACKGROUND OF THE DISCLOSURE

Wireless earbuds have gradually become popular, and users are gradually accustomed to the existing operation mode of the wireless earbuds, which leads to a stagnation in the improvement and development of the wireless earbuds.

### SUMMARY OF THE DISCLOSURE

In response to the above-referenced technical inadequacies, the present disclosure provides an intermediary device and a wearable bridge to effectively improve on the issues associated with conventional wireless earbuds.

In one aspect, the present disclosure provides an intermediary device, which includes a wearable bridge for being detachably assembled with two wireless earbuds that are configured as a pair and to be operated at the same time. The wearable bridge includes a headband, two ear cups, and a wireless module. The two ear cups are respectively connected to two opposite ends of the headband. Each of the two ear cups includes an assembling slot and an electrical connector that is arranged in the assembling slot. Each of the two ear cups is configured to assemble one of the two wireless earbuds into the assembling slot thereof so as to enable the corresponding electrical connector to be structurally and electrically connected to the one of the two wireless earbuds. The wireless module is electrically coupled to the electrical connector of each of the two ear cups. When the two wireless earbuds are respectively assembled in the two ear cups, the wireless module is configured to receive sound signals from an external apparatus and to transmit the sound signals to the electrical connectors of the two ear cups, so that the two wireless earbuds are allowed to synchronously play by receiving the sound signals from the electrical connectors of the two ear cups.

In certain embodiments, the wearable bridge includes a power transmission wire and a battery. The power transmission wire is arranged in the headband and is electrically connected to the electrical connectors of the two ear cups. The battery is electrically coupled to the power transmission wire, and the battery is configured to supply electricity to the two wireless earbuds through the power transmission wire and the electrical connectors of the two ear cups.

In certain embodiments, the battery is configured to charge the two wireless earbuds through the power transmission wire and the electrical connectors of the two ear cups.

In certain embodiments, the wearable bridge has no speaker for playing the sound signals from the external apparatus.

In certain embodiments, each of the two ear cups includes a magnetic member that is embedded in the assembling slot thereof and that is configured to be magnetically attracted with the corresponding wireless earbud.

In certain embodiments, the wearable bridge includes a signal transmission wire arranged in the headband. The signal transmission wire is electrically connected to the electrical connectors of the two ear cups so as to enable the electrical connectors of the two ear cups to be electrically coupled to each other.

In certain embodiments, the intermediary device further includes a dongle having a predetermined playing mode. The dongle is configured to be selectively inserted into the external apparatus, and the wireless module of the wearable bridge is electrically coupled to the dongle in a wireless manner.

In certain embodiments, when the two wireless earbuds are respectively assembled in the two ear cups and the dongle is inserted into the external apparatus, the wireless module is configured to receive the sound signals from the external apparatus through the dongle so as to allow the two wireless earbuds to play in the predetermined playing mode.

In another aspect, the present disclosure provides a wearable bridge for being detachably assembled with two wireless earbuds that are configured as a pair and to be operated at the same time. The wearable bridge includes a headband, two ear cups, and a signal transmission wire. The two ear cups are respectively connected to two opposite ends of the headband. Each of the two ear cups includes an assembling slot and an electrical connector that is arranged in the assembling slot. Each of the two ear cups is configured to assemble one of the two wireless earbuds into the assembling slot thereof so as to enable the corresponding electrical connector thereof to be structurally and electrically connected to the one of the two wireless earbuds. The signal transmission wire is arranged in the headband and is electrically connected to the electrical connectors of the two ear cups, so that the electrical connectors of the two ear cups are electrically coupled to each other. When the two wireless earbuds are respectively assembled in the two ear cups and receive sound signals from an external apparatus, the electrical connectors of the two ear cups and the signal transmission wire are configured to transmit the sound signals from the two wireless earbuds to each other, so that the two wireless earbuds are allowed to synchronously play after comparing the sound signals.

In certain embodiments, the wearable bridge further includes a power transmission wire and a battery. The power transmission wire is arranged in the headband and is electrically connected to the electrical connectors of the two ear cups. The battery is electrically coupled to the power transmission wire, and the battery is configured to supply electricity to the two wireless earbuds through the power transmission wire and the electrical connectors of the two ear cups.

In certain embodiments, the battery is configured to charge the two wireless earbuds through the power transmission wire and the electrical connectors of the two ear cups.

In certain embodiments, each of the two ear cups includes a magnetic member that is embedded in the assembling slot thereof and that is configured to be magnetically attracted with the corresponding wireless earbud.

In yet another aspect, the present disclosure provides an intermediary device, which includes a wearable bridge for being detachably assembled with a wireless earbud. The wearable bridge includes a headband, two ear cups, and a signal transmission wire. The two ear cups are respectively connected to two opposite ends of the headband. One of the two ear cups is defined as a first ear cup and includes an assembling slot and an electrical connector that is arranged in the assembling slot, and another one of the two ear cups is defined as a second ear cup and has a speaker. The first ear cup is configured to assemble the wireless earbud into the assembling slot so as to enable the electrical connector to be structurally and electrically connected to the wireless earbud. The signal transmission wire is arranged in the headband and is electrically connected to the electrical connector and the speaker, so that the electrical connector and the speaker are electrically coupled to each other.

In certain embodiments, when the wireless earbud is assembled in the first ear cup and receives sound signals from an external apparatus, the electrical connector and the signal transmission wire are configured to transmit the sound signals from the wireless earbud to the speaker, so that the wireless earbud and the speaker are allowed to synchronously play.

In certain embodiments, the wearable bridge includes a wireless module electrically coupled to the signal transmission wire. When the wireless earbud is assembled in the first ear cup, the wireless module is configured to receive sound signals from an external apparatus and to transmit the sound signals to the electrical connector and the speaker through the signal transmission wire, so that the wireless earbud and the speaker are allowed to synchronously play.

In certain embodiments, the intermediary device further includes a dongle that has a predetermined playing mode. The dongle is configured to be selectively inserted into the external apparatus, and the wireless module of the wearable bridge is electrically coupled to the dongle in a wireless manner.

In certain embodiments, when the wireless earbud is assembled in the first ear cup and the dongle is inserted into the external apparatus, the wireless module is configured to receive the sound signals from the external apparatus through the dongle so as to allow the wireless earbud and the speaker to play in the predetermined playing mode.

In certain embodiments, the wearable bridge includes a power transmission wire and a battery. The power transmission wire is arranged in the headband and is electrically connected to the electrical connector. The battery is electrically coupled to the power transmission wire, and the battery is configured to supply electricity to the wireless earbud through the power transmission wire and the electrical connector.

In certain embodiments, the battery is configured to charge the wireless earbud through the power transmission wire and the electrical connector.

In certain embodiments, the first ear cup includes a magnetic member that is embedded in the assembling slot thereof and that is configured to be magnetically attracted with the wireless earbud.

Therefore, the wearable bridge of the intermediary device in the present disclosure can be provided to effectively expand the application scope of at least one wireless earbud through the structural design thereof (e.g., the wearable bridge can be in cooperation with the at least one wireless earbud for jointly providing a playing effect of stereo handset).

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic exploded view showing a wearable bridge and two wireless earbuds according to a first embodiment of the present disclosure;

FIG. 2 is a schematic view showing the wearable bridge of FIG. 1 that is operated in a first mode by being assembled with two wireless earbuds;

FIG. 3 is a schematic view showing the wearable bridge of FIG. 1 that is operated in a second mode by being assembled with the two wireless earbuds and being cooperated with a dongle;

FIG. 4 is a schematic view showing the wearable bridge that is operated in the first mode by being assembled with the two wireless earbuds according to a second embodiment of the present disclosure;

FIG. 5 is a schematic exploded view showing the wearable bridge and a wireless earbud according to a third embodiment of the present disclosure;

FIG. 6 is a schematic view showing the wearable bridge of FIG. 5 that is operated in the first mode by being assembled with the wireless earbud;

FIG. 7 is a schematic view showing the wearable bridge of FIG. 5 that is operated in the second mode by being assembled with the wireless earbud and being cooperated with the dongle; and

FIG. 8 is a schematic view showing the wearable bridge that is operated in the first mode by being assembled with the wireless earbud according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

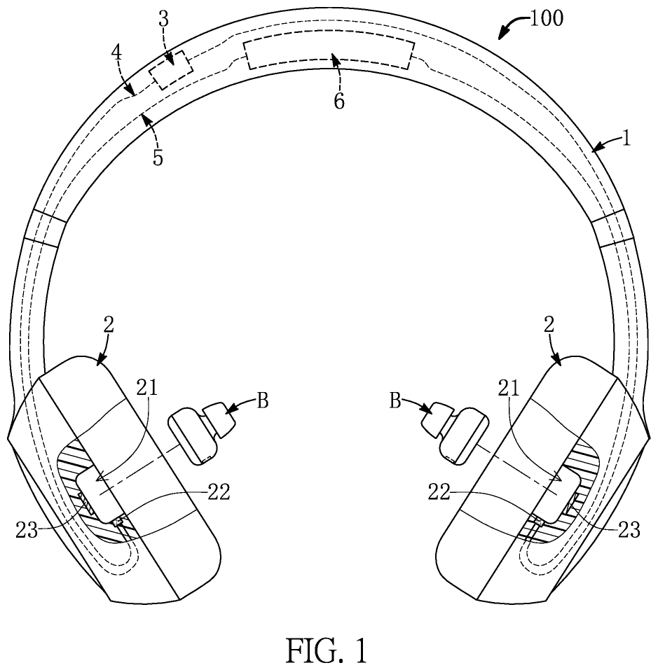

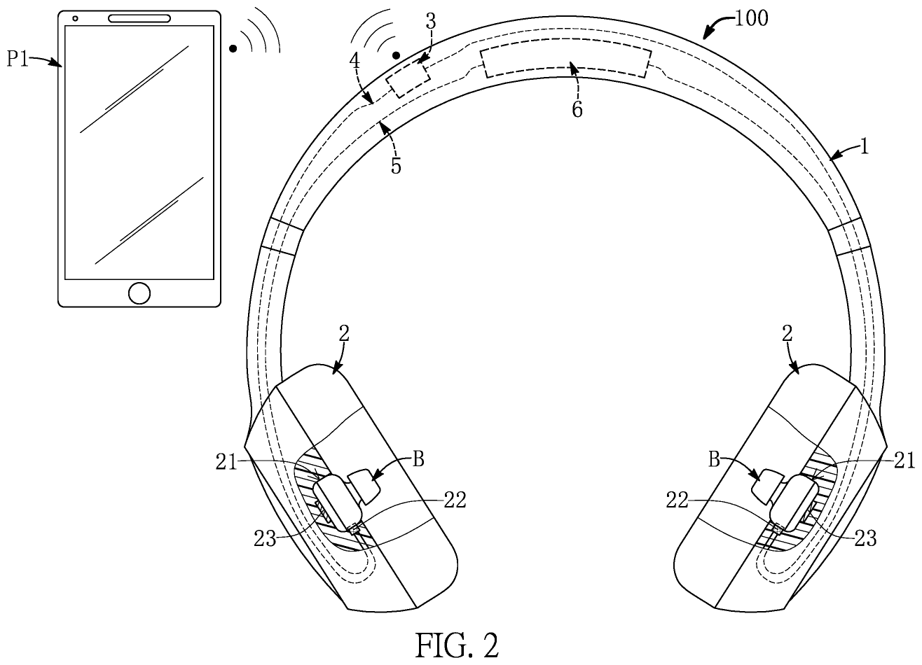

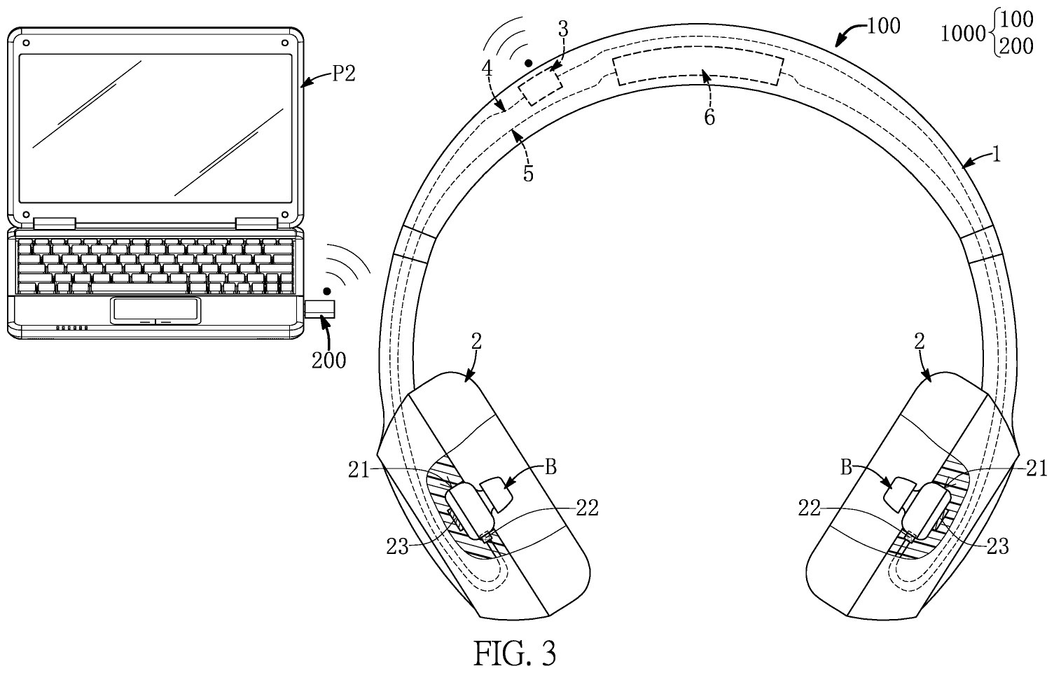

Referring to FIG. 1 to FIG. 3, a first embodiment of the present disclosure provides an intermediary device 1000. The intermediary device 100 in the present embodiment includes a wearable bridge 100 and a dongle 200 that is selectively connected to the wearable bridge 100 in a wireless manner, but the present disclosure is not limited thereto. For example, in other embodiments of the present disclosure not shown in the drawings, the wearable bridge 100 can be independently used (e.g., sold) or can be used in cooperation with other components.

The wearable bridge 100 is provided for being detachably assembled with two wireless earbuds B that are configured as a pair and to be operated at the same time. The two wireless earbuds B in the present embodiment can be the true wireless stereo (TWS) earbuds, but the present disclosure is not limited thereto. In other words, the wearable bridge 100 can be assembled with the two wireless earbuds B so as to be operated in a first mode, or the wearable bridge 100 can be assembled with the two wireless earbuds B and in cooperation with the dongle 200 so as to be operated in a second mode.

The following description describes the structure and connection relationship of each component of the wearable bridge 100, and then describes the cooperation between the wearable bridge 100 and the dongle 200. The wearable bridge 100 includes a headband 1 and two ear cups 2 that are respectively connected to two ends of the headband 1. In the present embodiment, each of the two ear cups 2 includes an assembling slot 21, an electrical connector 22 arranged in the assembling slot 21, and a magnetic member 23 (e.g., a magnet) that is embedded in the assembling slot 21 and that is located adjacent to the electrical connector 22.

Each of the two ear cups 2 is configured to assemble one of the two wireless earbuds B into the assembling slot 21 thereof so as to enable the corresponding electrical connector 22 to be structurally and electrically connected to the one of the two wireless earbuds B. The connection manner between each of the two ear cups 2 and the corresponding wireless earbud B can be implemented as follows. The electrical connector 22 has at least one electrical contact that is structurally and electrically connected to the wireless earbud B, and the magnetic member 23 is embedded in the assembling slot 21 and is configured to be magnetically attracted with the wireless earbud B, so that the wireless earbud B can be firmly assembled in the assembling slot 21, but the present disclosure is not limited thereto. For example, in other embodiments of the present disclosure not shown in the drawings, the assembling slot 21 and the wireless earbud B can be structurally engaged with each other by corresponding in shape to each other, so that the magnetic member 23 can be omitted.

Specifically, an interior of the wearable bridge 100 (e.g., an interior of at least one of the headband 1 and the two ear cups 2) includes a wireless module 3 (e.g., a Bluetooth® module), a signal transmission wire 4, a power transmission wire 5, and a battery 6 (e.g., a rechargeable battery), but the present disclosure is not limited thereto. For example, in other embodiments of the present disclosure not shown in the drawings, the power transmission wire 5, and the battery 6 can be omitted or can be replaced by other components.

The signal transmission wire 4 is arranged in the headband 1 and is electrically connected to the electrical connectors 22 of the two ear cups 2, so as to enable the electrical connectors 22 of the two ear cups 2 to be electrically coupled to each other. The wireless module 3 can be electrically coupled to the electrical connectors 22 of the two ear cups 2 through the signal transmission wire 4.

In summary, when the two wireless earbuds B are respectively assembled in the two ear cups 2 (e.g., when the wearable bridge 100 is operated in the first mode), the wireless module 3 is configured to receive sound signals from an external apparatus P1 (e.g., a cell phone) and to transmit the sound signals to the electrical connectors 22 of the two ear cups 2 through the signal transmission wire 4, so that the two wireless earbuds B are allowed to synchronously play by receiving the sound signals from the electrical connectors 22 of the two ear cups 2.

Accordingly, the wearable bridge 100 of the present embodiment can be provided to effectively expand the application scope of the wireless earbuds B through the structural design thereof (e.g., the wearable bridge 100 can be in cooperation with the two wireless earbuds B for jointly providing a playing effect of stereo handset).

In the present embodiment, the wearable bridge 100 preferably has no speaker for playing the sound signals from the external apparatus P1. In other words, when the wearable bridge 100 is not assembled with the two wireless earbuds B, the wearable bridge 100 cannot play the sound signals from the external apparatus P1.

Moreover, the power transmission wire 5 is arranged in the headband 1 and is electrically connected to the electrical connectors 22 of the two ear cups 2, and the battery 6 is electrically coupled to the power transmission wire 5, so that the battery 6 is configured to supply electricity to the two wireless earbuds B through the power transmission wire 5 and the electrical connectors 22 of the two ear cups 2. Specifically, the battery 6 is configured to charge the two wireless earbuds B through the power transmission wire 5 and the electrical connectors 22 of the two ear cups 2.

In addition, the wearable bridge 100 in the present embodiment is used to charge the two wireless earbuds B through the single battery 6 and the power transmission wire 5, but the present disclosure is not limited thereto. For example, in other embodiments of the present disclosure not shown in the drawings, the wearable bridge 100 includes a plurality of batteries 6 and a plurality of power transmission wires 5, and each of the two wireless earbuds B can be independently charged through one of the batteries 6 and the corresponding power transmission wire 5.

The above description of the present embodiment describes the wearable bridge 100 that is operated in the first mode. Moreover, the wearable bridge 100 can be electrically coupled to the dongle 200 in a wireless manner through the wireless module 3. The dongle 200 has a predetermined playing mode, and the dongle 200 is configured to be selectively inserted into an external apparatus P2 (e.g., a laptop computer or a desktop computer).

Specifically, when the two wireless earbuds B are respectively assembled in the two ear cups 2 and the dongle 200 is inserted into the external apparatus P2, the wireless module 3 can be electrically coupled to the dongle 200 for enabling the wearable bridge 100 to automatically switch to the second mode, and the wireless module 3 is configured to receive the sound signals from the external apparatus P2 through the dongle 200 so as to allow the two wireless earbuds B to play in the predetermined playing mode. For example, the predetermined playing mode can be an ultra-low latency mode that is suitable for playing game and that enables to tolerate a certain amount of packet loss, or can be specified connection mode, but the present disclosure is not limited thereto.

Accordingly, the intermediary device 1000 of the present embodiment can further expand the application scope of the two wireless earbuds B through the cooperation between the wearable bridge 100 and the dongle 200. For example, the two wireless earbuds B can be selectively operated in the predetermined playing mode through the intermediary device 1000 according to different requirements.

Furthermore, in the above description, the wearable bridge 100 operated in the first mode or the second mode is configured to receive the sound signals from the external apparatus P1, P2 through the wireless module 3, but the present disclosure is not limited thereto. For example, the wireless module 3 can be only operated in the second mode; therefore, when the wearable bridge 100 is operated in the first mode, the two wireless earbuds B can be used to receive the sound signals from the external apparatus P1, and the signal transmission wire 4 is configured to transmit the sound signals from the two wireless earbuds B to each other, so that the two wireless earbuds B are allowed to synchronously play after comparing the sound signals (e.g., the wearable bridge 100 can be in cooperation with the two wireless earbuds B for jointly providing a playing effect of stereo handset).

### Second Embodiment

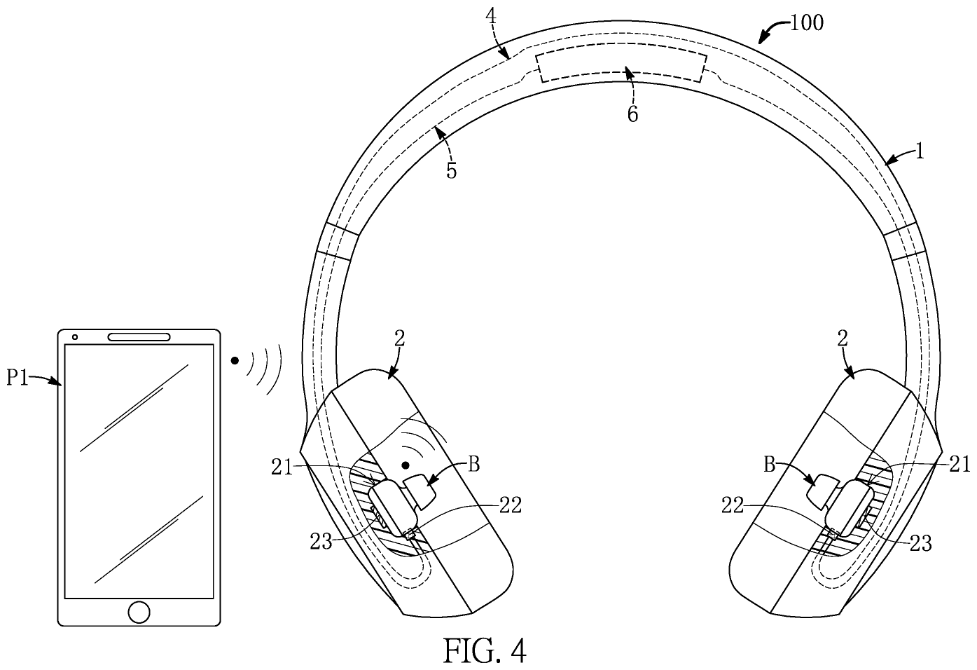

Referring to FIG. 4, a second embodiment of the present disclosure is provided, which is similar to the first embodiment of the present disclosure. For the sake of brevity, descriptions of the same components in the first and second embodiments of the present disclosure will be omitted herein, and the following description only discloses different features between the first and second embodiments.

In the present embodiment, the wearable bridge 100 is provided without the wireless module 3, so that the wearable bridge 100 is not in cooperation with the dongle 200. In other words, the wearable bridge 100 of the present embodiment can be only operated in the first mode by assembling the two wireless earbuds B, and cannot be operated in the second mode.

Specifically, when the two wireless earbuds B are respectively assembled in the two ear cups 2 and receive sound signals from an external apparatus P1, the electrical connectors 22 of the two ear cups 2 and the signal transmission wire 4 are configured to transmit the sound signals from the two wireless earbuds B to each other, so that the two wireless earbuds B are allowed to synchronously play after comparing the sound signals.

### Third Embodiment

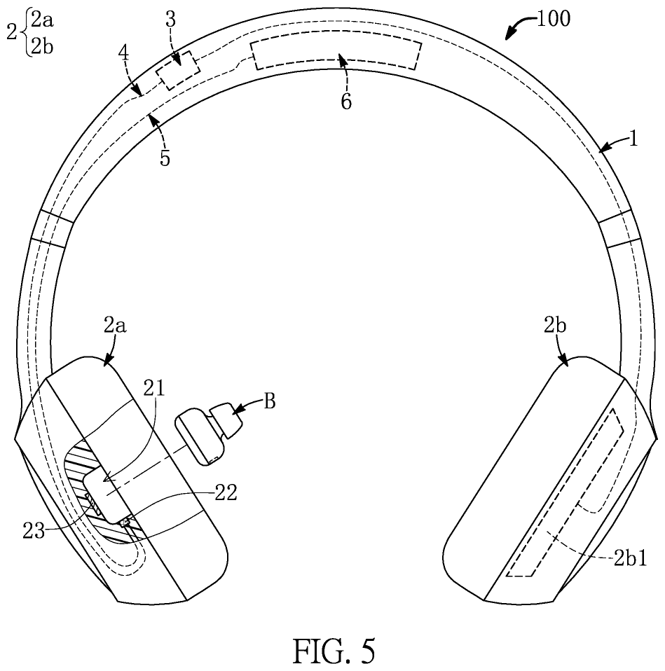

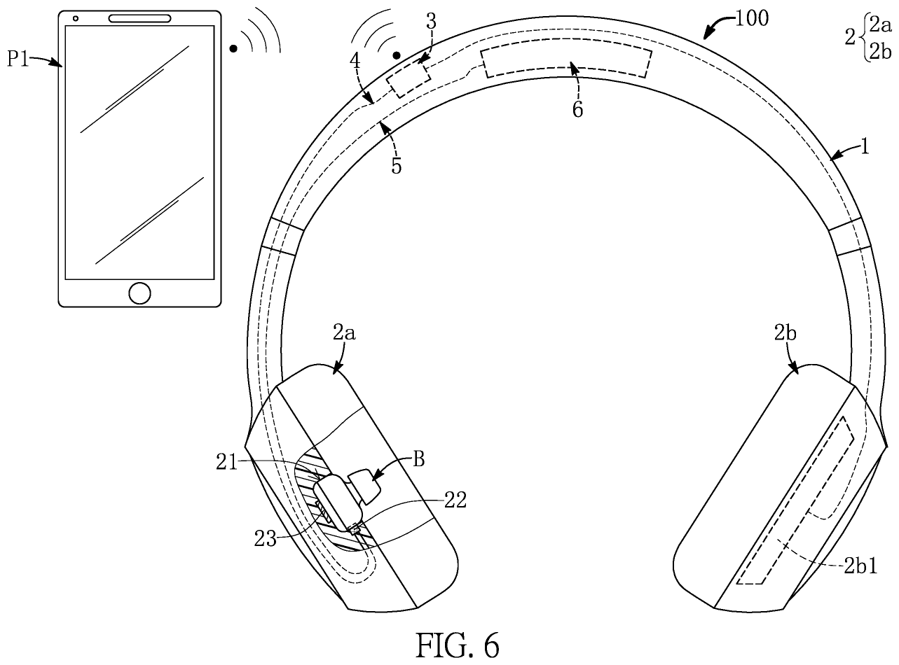

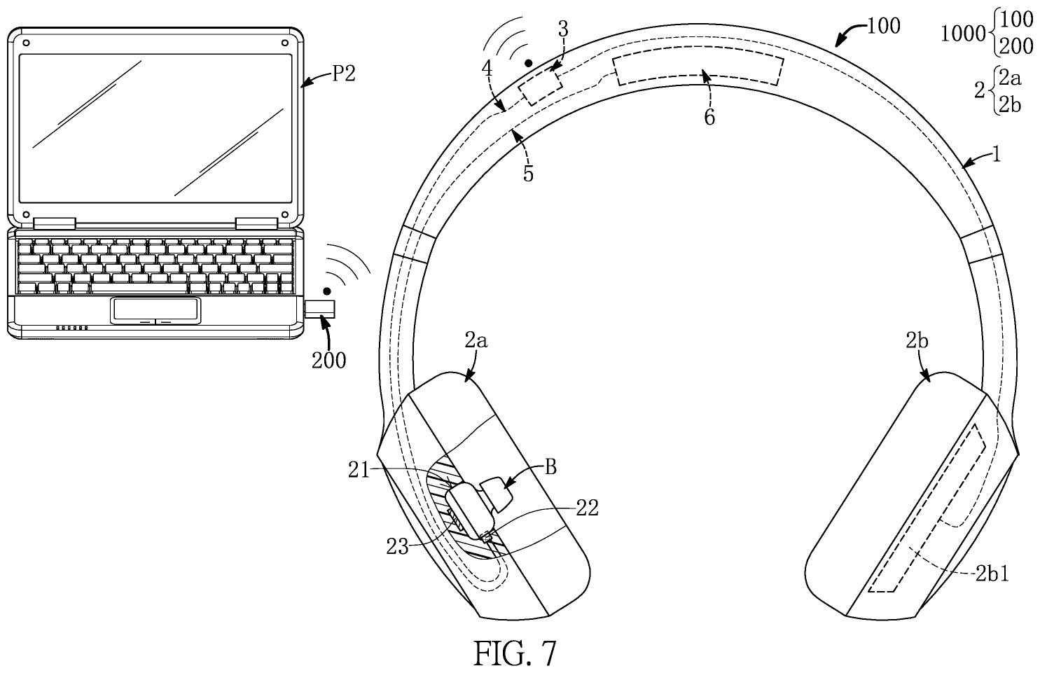

Referring to FIG. 5 to FIG. 7, a third embodiment of the present disclosure provides an intermediary device 100. The intermediary device 100 in the present embodiment includes a wearable bridge 100 and a dongle 200 that is selectively connected to the wearable bridge 100 in a wireless manner, but the present disclosure is not limited thereto. For example, in other embodiments of the present disclosure not shown in the drawings, the wearable bridge 100 can be independently used (e.g., sold) or can be used in cooperation with other components.

The wearable bridge 100 is provided for being detachably assembled with a wireless earbud B. The wireless earbud B in the present embodiment can be the true wireless stereo (TWS) earbud, but the present disclosure is not limited thereto. In other words, the wearable bridge 100 can be assembled with the wireless earbud B so as to be operated in a first mode, or the wearable bridge 100 can be assembled with the wireless earbud B and in cooperation with the dongle 200 so as to be operated in a second mode.

The following description describes the structure and connection relationship of each component of the wearable bridge 100, and then describes the cooperation between the wearable bridge 100 and the dongle 200. The wearable bridge 100 includes a headband 1 and two ear cups 2 that are respectively connected to two ends of the headband 1. In the present embodiment, one of the two ear cups 2 is defined as a first ear cup 2a and includes an assembling slot 21, an electrical connector 22 arranged in the assembling slot 21, and a magnetic member 23 (e.g., a magnet) that is embedded in the assembling slot 21 and that is located adjacent to the electrical connector 22; another one of the two ear cups 2 is defined as a second ear cup 2b and has a speaker 2b1.

The first ear cup 2a is configured to assemble the wireless earbud B into the assembling slot 21 thereof so as to enable the electrical connector 22 to be structurally and electrically connected to the wireless earbud B. The connection manner between the first ear cup 2a and the wireless earbud B can be implemented as follows. The electrical connector 22 has at least one electrical contact that is structurally and electrically connected to the wireless earbud B, and the magnetic member 23 is embedded in the assembling slot 21 and is configured to be magnetically attracted with the wireless earbud B, so that the wireless earbud B can be firmly assembled in the assembling slot 21, but the present disclosure is not limited thereto. For example, in other embodiments of the present disclosure not shown in the drawings, the assembling slot 21 and the wireless earbud B can be structurally engaged with each other by corresponding in shape to each other, so that the magnetic member 23 of the first ear cup 2a can be omitted.

Specifically, an interior of the wearable bridge 100 (e.g., an interior of at least one of the headband 1 and the two ear cups 2) includes a wireless module 3 (e.g., a Bluetooth® module), a signal transmission wire 4, a power transmission wire 5, and a battery 6 (e.g., a rechargeable battery), but the present disclosure is not limited thereto. For example, in other embodiments of the present disclosure not shown in the drawings, the power transmission wire 5, and the battery 6 can be omitted or can be replaced by other components.

The signal transmission wire 4 is arranged in the headband 1 and is electrically connected to the electrical connector 22 of the first ear cup 2a and the speaker 2b1 of the second ear cup 2b, so as to enable the electrical connector 22 and the speaker 2b1 to be electrically coupled to each other. The wireless module 3 can be electrically coupled to the electrical connector 22 of the first ear cup 2a and the speaker 2b1 of the second ear cup 2b through the signal transmission wire 4.

In summary, when the wireless earbud B is assembled in the first ear cup 2a (e.g., when the wearable bridge 100 is operated in the first mode), the wireless module 3 is configured to receive sound signals from an external apparatus P1 (e.g., a cell phone) and to transmit the sound signals to the electrical connector 22 and the speaker 2b1 through the signal transmission wire 4, so that the wireless earbud B and the speaker 2b1 are allowed to synchronously play.

In the present embodiment, the first ear cup 2a of the wearable bridge 100 preferably has no speaker for playing the sound signals from the external apparatus P1. In other words, when the first ear cup 2a of the wearable bridge 100 is not assembled with the wireless earbud B, the wearable bridge 100 cannot play the sound signals from the external apparatus P1.

Moreover, the power transmission wire 5 is arranged in the headband 1 and is electrically connected to the electrical connector 22 of the first ear cup 2a, and the battery 6 is electrically coupled to the power transmission wire 5, so that the battery 6 is configured to supply electricity to the wireless earbud B through the power transmission wire 5 and the electrical connector 22 of the first ear cup 2a. Specifically, the battery 6 is configured to charge the wireless earbud B through the power transmission wire 5 and the electrical connector 22 of the first ear cup 2.

The above description of the present embodiment describes the wearable bridge 100 that is operated in the first mode. Moreover, the wearable bridge 100 can be electrically coupled to the dongle 200 in a wireless manner through the wireless module 3. The dongle 200 has a predetermined playing mode, and the dongle 200 is configured to be selectively inserted into an external apparatus P2 (e.g., a laptop computer or a desktop computer).

Specifically, when the wireless earbud B is assembled in the first ear cup 2a and the dongle 200 is inserted into the external apparatus P2, the wireless module 3 can be electrically coupled to the dongle 200 for enabling the wearable bridge 100 to automatically switch to the second mode, and the wireless module 3 is configured to receive the sound signals from the external apparatus P2 through the dongle 200 so as to allow the wireless earbud B and the speaker 2b1 to play in the predetermined playing mode. For example, the predetermined playing mode can be an ultra-low latency mode that is suitable for playing game and that enables to tolerate a certain amount of packet loss, or can be specified connection mode, but the present disclosure is not limited thereto.

Furthermore, in the above description, the wearable bridge 100 operated in the first mode or the second mode is configured to receive the sound signals from the external apparatus P1, P2 through the wireless module 3, but the present disclosure is not limited thereto. For example, the wireless module 3 can be only operated in the second mode; therefore, when the wearable bridge 100 is operated in the first mode, the wireless earbud B can be used to receive the sound signals from the external apparatus P1, and the signal transmission wire 4 is configured to transmit the sound signals from the wireless earbud B to the speaker 2b1, so that the wireless earbud B and the speaker 2b1 are allowed to synchronously play.

### Fourth Embodiment

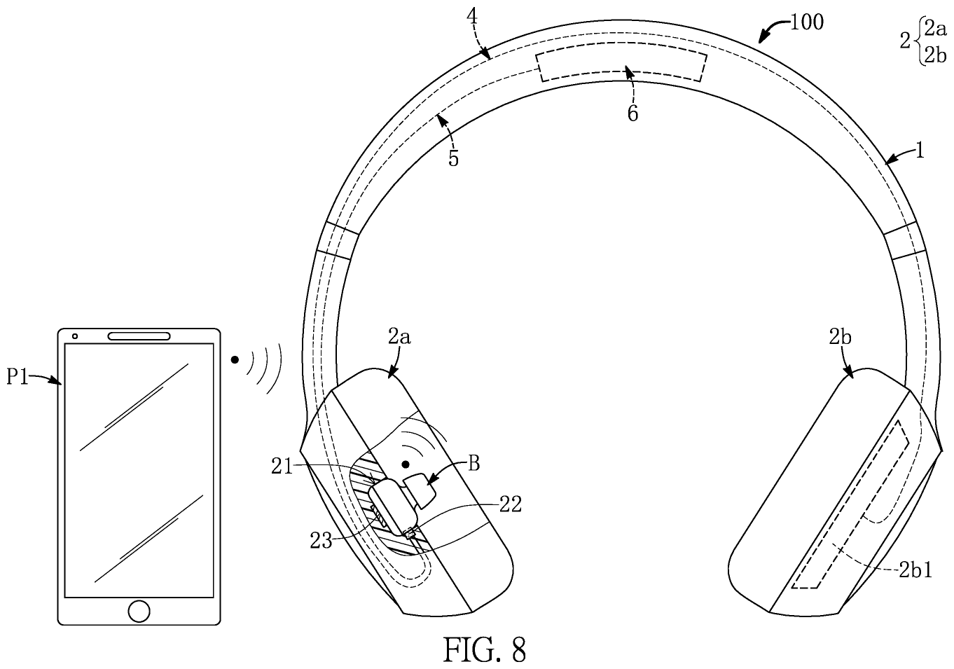

Referring to FIG. 8, a fourth embodiment of the present disclosure is provided, which is similar to the third embodiment of the present disclosure. For the sake of brevity, descriptions of the same components in the third and fourth embodiments of the present disclosure will be omitted herein, and the following description only discloses different features between the third and fourth embodiments.

In the present embodiment, the wearable bridge 100 is provided without the wireless module 3, so that the wearable bridge 100 is not in cooperation with the dongle 200. In other words, the wearable bridge 100 of the present embodiment can be only operated in the first mode by assembling the wireless earbud B, and cannot be operated in the second mode.

Specifically, when the wireless earbud B is assembled in the first ear cup 2a and receive sound signals from an external apparatus P1, the electrical connector 22 of the first ear cup 2a and the signal transmission wire 4 are configured to transmit the sound signals from the wireless earbud B to the speaker 2b1, so that the wireless earbud B and the speaker 2b1 are allowed to synchronously play.

### Beneficial Effects of the Embodiments

In conclusion, the wearable bridge of the present disclosure can be provided to effectively expand the application scope of the at least one wireless earbud through the structural design thereof (e.g., the wearable bridge can be in cooperation with the at least one wireless earbud for jointly providing a playing effect of stereo handset).

Moreover, the intermediary device of the present disclosure can further expand the application scope of the at least one wireless earbud through the cooperation between the wearable bridge and the dongle. For example, the at least one wireless earbud can be selectively operated in the predetermined playing mode through the intermediary device according to different requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An intermediary device, comprising:
a wearable bridge for being detachably assembled with two wireless earbuds that are configured as a pair and to be operated at the same time, wherein the wearable bridge includes:
a headband;
two ear cups respectively connected to two opposite ends of the headband, wherein each of the two ear cups includes an assembling slot and an electrical connector that is arranged in the assembling slot, and wherein each of the two ear cups is configured to assemble one of the two wireless earbuds into the assembling slot thereof so as to enable the corresponding electrical connector to be structurally and electrically connected to the one of the two wireless earbuds; and
a wireless module electrically coupled to the electrical connector of each of the two ear cups,
wherein, when the two wireless earbuds are respectively assembled in the two ear cups, the wireless module is configured to receive sound signals from an external apparatus and to transmit the sound signals to the electrical connectors of the two ear cups, so that the two wireless earbuds are allowed to synchronously play by receiving the sound signals from the electrical connectors of the two ear cups.

2. The intermediary device according to claim 1, wherein the wearable bridge includes:
a power transmission wire arranged in the headband and electrically connected to the electrical connectors of the two ear cups; and
a battery electrically coupled to the power transmission wire, wherein the battery is configured to supply electricity to the two wireless earbuds through the power transmission wire and the electrical connectors of the two ear cups.

3. The intermediary device according to claim 2, wherein the battery is configured to charge the two wireless earbuds through the power transmission wire and the electrical connectors of the two ear cups.

4. The intermediary device according to claim 1, wherein the wearable bridge has no speaker for playing the sound signals from the external apparatus.

5. The intermediary device according to claim 1, wherein each of the two ear cups includes a magnetic member that is embedded in the assembling slot thereof and that is configured to be magnetically attracted with the corresponding wireless earbud.

6. The intermediary device according to claim 1, wherein the wearable bridge includes a signal transmission wire arranged in the headband, and wherein the signal transmission wire is electrically connected to the electrical connectors of the two ear cups so as to enable the electrical connectors of the two ear cups to be electrically coupled to each other.

7. The intermediary device according to claim 1, further comprising a dongle having a predetermined playing mode, wherein the dongle is configured to be selectively inserted into the external apparatus, and the wireless module of the wearable bridge is electrically coupled to the dongle in a wireless manner.

8. The intermediary device according to claim 7, wherein, when the two wireless earbuds are respectively assembled in the two ear cups and the dongle is inserted into the external apparatus, the wireless module is configured to receive the sound signals from the external apparatus through the dongle so as to allow the two wireless earbuds to play in the predetermined playing mode.

9. A wearable bridge for being detachably assembled with two wireless earbuds that are configured as a pair and to be operated at the same time, the wearable bridge comprising:
a headband;
two ear cups respectively connected to two opposite ends of the headband, wherein each of the two ear cups includes an assembling slot and an electrical connector that is arranged in the assembling slot, and wherein each of the two ear cups is configured to assemble one of the two wireless earbuds into the assembling slot thereof so as to enable the corresponding electrical connector thereof to be structurally and electrically connected to the one of the two wireless earbuds; and
a signal transmission wire that is arranged in the headband and electrically connected to the electrical connectors of the two ear cups, so that the electrical connectors of the two ear cups are electrically coupled to each other;
wherein, when the two wireless earbuds are respectively assembled in the two ear cups and receive sound signals from an external apparatus, the electrical connectors of the two ear cups and the signal transmission wire are configured to transmit the sound signals from the two wireless earbuds to each other, so that the two wireless earbuds are allowed to synchronously play after comparing the sound signals.

10. The wearable bridge according to claim 9, further comprising:
a power transmission wire arranged in the headband and electrically connected to the electrical connectors of the two ear cups; and
a battery electrically coupled to the power transmission wire, wherein the battery is configured to supply electricity to the two wireless earbuds through the power transmission wire and the electrical connectors of the two ear cups.

11. The wearable bridge according to claim 10, wherein the battery is configured to charge the two wireless earbuds through the power transmission wire and the electrical connectors of the two ear cups.

12. The wearable bridge according to claim 9, wherein each of the two ear cups includes a magnetic member that is embedded in the assembling slot thereof and that is configured to be magnetically attracted with the corresponding wireless earbud.

13. An intermediary device, comprising:
a wearable bridge for being detachably assembled with a wireless earbud, wherein the wearable bridge includes:
a headband;
two ear cups respectively connected to two opposite ends of the headband, wherein one of the two ear cups is defined as a first ear cup and includes an assembling slot and an electrical connector that is arranged in the assembling slot, and another one of the two ear cups is defined as a second ear cup and has a speaker, and wherein the first ear cup is configured to assemble the wireless earbud into the assembling slot so as to enable the electrical connector to be structurally and electrically connected to the wireless earbud; and
a signal transmission wire arranged in the headband and electrically connected to the electrical connector and the speaker, so that the electrical connector and the speaker are electrically coupled to each other.

14. The intermediary device according to claim 13, wherein, when the wireless earbud is assembled in the first ear cup and receives sound signals from an external apparatus, the electrical connector and the signal transmission wire are configured to transmit the sound signals from the wireless earbud to the speaker, so that the wireless earbud and the speaker are allowed to synchronously play.

15. The intermediary device according to claim 13, wherein the wearable bridge includes a wireless module electrically coupled to the signal transmission wire, and wherein, when the wireless earbud is assembled in the first ear cup, the wireless module is configured to receive sound signals from an external apparatus and to transmit the sound signals to the electrical connector and the speaker through the signal transmission wire, so that the wireless earbud and the speaker are allowed to synchronously play.

16. The intermediary device according to claim 15, further comprising a dongle that has a predetermined playing mode, wherein the dongle is configured to be selectively inserted into the external apparatus, and the wireless module of the wearable bridge is electrically coupled to the dongle in a wireless manner.

17. The intermediary device according to claim 16, wherein, when the wireless earbud is assembled in the first ear cup and the dongle is inserted into the external apparatus, the wireless module is configured to receive the sound signals from the external apparatus through the dongle so as to allow the wireless earbud and the speaker to play in the predetermined playing mode.

18. The intermediary device according to claim 13, wherein the wearable bridge includes:
a power transmission wire arranged in the headband and electrically connected to the electrical connector; and
a battery electrically coupled to the power transmission wire, wherein the battery is configured to supply electricity to the wireless earbud through the power transmission wire and the electrical connector.

19. The intermediary device according to claim 18, wherein the battery is configured to charge the wireless earbud through the power transmission wire and the electrical connector.

20. The intermediary device according to claim 13, wherein the first ear cup includes a magnetic member that is embedded in the assembling slot thereof and that is configured to be magnetically attracted with the wireless earbud.
